(19) United States
(12) Patent Application Publication
(10) Pub. No.: US 2002/0062922 A1
(43) Pub. Date: May 30, 2002

(54) Business method for indicia with sanitized food and beverage cans and other containers

(76) Inventor: Cali St. John, Miami, FL (US)

Correspondence Address: ROBERT J. VAN DER WALL, Esq., Suite #5100, 200 South Biscayne Boulevard, Miami, FL, 33131-2310, US

(21) Appl. No.: 09/951,723

(22) Filed: Sep. 14, 2001

Related U.S. Application Data
(63) Continuation-in-part of application No. 09/637,242, filed on Aug. 14, 2000.
(60) Provisional application No. 60/155,574, filed on Sep. 24, 1999.

(51) Int. Cl. B32B 3/04

(52) U.S. Cl. 156/292; 156/216

(57) ABSTRACT

Disclosed is a new business method that employs an indicia bearing protective member for use in combination with an at least partially sanitized food or beverage container, which member comprises primarily a substantially hourglass shaped piece of thin material of suitable dimension which is adhered to the containers. Alternatively, a substantially circular member may be used, in which event the member is applied within the rim of the top of the container. The hourglass shape permits adherence to the top and convex side of a container without deformation of the protective member's material, without wrinkling, and without the application of heat. Adherence is preferably achieved with antibacterial, transparent adhesive. The apparatus is a consumer removed, flexible, transparent, biodegradable protective member adhered to at least the top area of the container, in which the protective member is combined with indicia that may be replaceable, paid, third party advertising, promotions, games of chance, premiums, collectibles, redeemables, merchandise acquisition means, discounts, and prizes, as well as such things as public service announcements, instructional information, and warnings.

### CROSS REFERENCE TO OTHER APPLICATIONS

This application is a continuation-in-part to Applicant's earlier application, Ser. No. 09/637,242 filed Aug. 14, 2000, which claims benefit of provisional application Serial No. 60/155,574 filed Sep. 24, 1999. This application is copending therewith and claims the filing date thereof as to the common subject matter.

### BACKGROUND OF THE INVENTION

1. Field of the Invention

This invention relates to the field of indicia in combination with sanitized and protected food and beverage cans or other containers such are used to contain and consume soda, beer, juice, soup, etc. More specifically, it relates to a business method that results in a new source of revenue, i.e., a new business. It employs a protective member having the revenue producing indicia on cans or other containers, which have been sanitized and protected from contamination after sanitization. The apparatus is a consumer removed, flexible, biodegradable protective member adhered to the container, in which the protective member is combined with indicia that may be replaceable, paid, third party advertising, promotions, games of chance, premiums, collectibles, redeemables, merchandise acquisition means, discounts and prizes, as well as such things as public service announcements, instructional information, and warnings. The protective member may contain hidden indicia covered over by an opaque layer as would occur when the indicia is visible only on the underside of the protective member and thus would be visible through a transparent protective member and transparent adhesive after being removed from the container.

For beverage cans, the method contemplates sanitization of at least the portion of the container that comes in contact with a consumer's mouth, adhering a protective member to the container, which member covers the mouth contact area on the top, rim and side of the container, and adherence of the protective member to the container. For soup cans and other food cans, the method contemplates sanitization of at least the portion of the container that comes in contact with the blade of a can opener, adhering a protective member to the container in similar fashion. At the same time, in either case it provides the consumer with visible assurance that the container in question has been the subject of sanitization and protection during container filling, shipment, distribution, storage, sale, consumer transportation, opening and consumer re-closure if desired. It also contemplates the sale of the above described types of indicia, the application, such as by printing, of same on the protective members, and the collection of money from such third parties in what may viewed as a new business method.

2. Description of Prior Art

Today's society is well acquainted with the so called “pop top” aluminum can which doubles both as a pressurized beverage container and drinking device. Also in common use are the usually small “tin” peel strip cans, frequently containing fruit juices which are not pressurized, contain an aperture at the top for beverage consumption, and include a tightly adhered flexible strip which is removed for consumption of the beverage.

While the pop-top can and peel strip cans are sometimes used with cups as the beverage-consuming medium, they are designed and are perhaps much more frequently used as a beverage-consuming container. The position of the container aperture is designed to facilitate convenient consumption directly from the container because the aperture is disposed near but not right at the rim of the top thereof.

Manufacture of these containers and the filling of same with a beverage and sealing thereof is well known to be done by highly automated machinery under what are assumed to be sanitary conditions. Nevertheless, in this age of greatly expanded scientific knowledge and heightened health consciousness, it seems incongruous to rely upon an assumption that such containers are safe to use as a beverage consuming container. That is particularly so since the overwhelming majority of the time that such beverage containers are also used as a consumption device, there is no means readily available to sanitize such containers before they are used for consumption, and there are certainly no means available to assure that they are safe for that purpose. The same issue applies to soup and other food containers even though they are not usually used for consumption, because penetration of the can by the can opener blade may result in contamination of the contents if the exterior of the can was not sanitized or protected.

There has been a certain amount of inventive activity focused on this concern. For example, Howard, U.S. Pat. No. 4,927,048 discloses a protective covering for the closure of a beverage can. It constitutes an aluminum foil that is glued to the can and has a tear away access strip to expose the pouring aperture. This access strip remains attached to the protective covering even after it has been torn to expose the pouring aperture.

Similarly, Cho, U.S. Pat. No. 5,813,559 discloses a beverage can having a sanitary covering rotatively attached to the top of the can by a rivet. The covering includes the lip portion of the rim nearest opening cover of the can during storage.

Another reference of interest is Chang, et al., U.S. Pat. No. 5,813,561. This invention includes a can lid having a center platform where the pull tab is raised from below the rim of a can to a position above the rim and wherein the center platform diameter is reduced in diameter to provide additional space from the exterior of the can body to the edge of the platform. The raised center platform prevents the user's lip from coming in contact with the groove along the edge of the lid, wherein it is alleged that dirt may accumulate.

A further reference, is Granofsky, U.S. Pat. No. 5,119,955 which discloses a closure device in which a principal focus concerns resealing the can using a reinsertable plug portion when less than the entire contents of the container are consumed. It includes an integral plastic member extending around the upper end portion of the can including the sidewall and end wall thereof.

Another reference is Granofsky, U.S. Pat. No. 5,108,003 which is similar to the preceding reference but includes a flexible member in a severable strip along its lower edge allowing the cover to be peeled back to allow for opening of the container. Half the cover can be folded away while the remainder remains adhesively secure to the container.

One more interesting reference is that of Eberhart, U.S. Pat. No. 4,749,100 which is a snap on lid type of device removably attached to the upper marginal lip of a beverage can covering the top surface to prevent the entry of dirt prior to the use of the can.

Next, there is the disclosure of Hammond, U.S. Pat. No. 5,014,869 which concerns a can sealing organization involving a plurality of beverage containers. Each cap number is heat-sealed in circumferential relationship to the top of each container, and each cap member includes an antiseptically saturated sponge mounted beneath the cap and containing a rupturable antibacterial fluid for use at the appropriate time.

Finally, there is the disclosure of Labbe, U.S. Pat. No. 5,657,149, which teaches a disc cover over the top of a beverage can, but lacks any notion of replaceable third party paid indicia and other features of the present invention.

It is noted, however, that none of these references appear to take into consideration the fact that a beverage container, when used as consumption means, requires more than concern for the sanitation of its lid and very upper sidewall. It is easy to recognize that the inside of the lower lip is held against the sidewall of the beverage can when the same is used for consumption. The foregoing references utterly fail to address the concern that the inside of the consumer's mouth comes in direct contact with the exterior sidewall of the container. Therefore, the prior art does not adequately deal with the sanitation issue of the sidewall of a beverage container, leaving the consumer to rely solely upon the initially mentioned assumption for safety.

At the same time, a new trend in the advertising industry has been to develop new and innovative sites for the placement of revenue producing advertising. An outstanding example of this has been the placement of removable and replaceable third party paid advertising inside of golf holes. In the context of this invention, the term “third party” advertisement contemplates an arms length advertiser that is ordinarily neither the supplier of the invention nor the food or beverage seller on which the invention is employed, although neither is precluded.

Typical of this type of technology are a number of issued U.S. patents. Examples are Boudreau, U.S. Pat. No. 4,928,417, Boudreau, et al., U.S. Pat. No. 4,878,665, Dark, U.S. Pat. No. 5,249,384, Hannon, U.S. Pat. No. 5,190,283, Hageman, U.S. Pat. No. 5,362,044, and Mabie, U.S. Pat. No. 5,788,581. So far as is presently known, there are no issued patents teaching the provision of a device for the sanitization and subsequent protection of the entire mouth contact area of a beverage container using a protective member, and almost certainly there are no patents on the placement of removable and replaceable third party paid advertising on such a food or beverage container protective member.

Of course the same thing is almost certainly true concerning the other types of indicia described above, such as promotions, games of chance, premiums, collectibles, redeemables, merchandise acquisition means, discounts, and prizes, as well as such things as public service announcements, instructional information, and warnings.

### SUMMARY OF THE INVENTION

Bearing in mind the foregoing, it is a principal object of the present invention to provide a business method and enabling apparatus whereby food and beverage containers may be sanitized and protected from contamination after sanitization by employing a consumer removed, flexible, protective member, which member also provides the site of replaceable, paid, third party indicia, a concept that is new to the beverage container and food can industry.

Another principal object of the invention is to provide the consuming public with a visible structure that constitutes a tamper evident protector to provide assurance that the food or beverage container in question has been the subject of sanitization and protection after container filling and sealing, and prior to shipment, distribution, storage, sale, consumer transportation and opening, while at the same time providing a revenue stream from replaceable, paid, third party indicia to offset the cost of the invention or to produce a profit as a separate business.

An additional object of the invention is to provide a method which contemplates sanitization of a food or beverage container, attachment of protective member to the container, which member covers the mouth contact area on the top, rim and side of the container, adherence of the protective member to the container prior to shipment, distribution, storage, sale, and consumer transportation of the container, at least partial removal of the protective member by the consumer during opening of the container, as well as the selling, printing and distribution of indicia in a new medium.

Another object of the invention is to provide a protective member which is readily employed by the consumer, easily removed, and does not interfere with consumption of the contents when the container is used as a beverage consumption device, and is also a new business revenue source from paid indicia from a third party.

A variation of the preceding object of the invention is to imprint the protective member with indicia, such as that which may tout the advantages and safety of the invention, or which may be printed with text and/or graphics for promotions, premiums, discounts or prizes, or which may include public service announcements, instructional information, warnings and the like.

A related object of the invention is to employ this imprinted indicia as an a medium that is contemplated to produce a revenue stream from third parties such that the costs of the invention are at least in part paid by such third parties, or more beneficially, a new business yielding separate profits from such indicia is achieved.

It is another object of the present invention to provide a site for replaceable third party paid indicia in combination with an apparatus and method whereby food and beverage containers may be sanitized and protected from contamination after sanitization by employing a consumer removed, flexible, protective member, with that member being the indicia site.

Another related object of the invention to provide a site for placement of additional indicia or promotional materials that do not use antibacterial adhesive or are otherwise specially prepared for proximity to foods or beverages because the protective member acts as an isolating layer so that inexpensive or unconventional indicia can be safely added to food and beverage containers.

A further object of the invention is to provide a protective member which is optionally reattachable to the mouth contact area of a beverage container in the event that the entire contents thereof are not consumed all at the same time.

A related object of the invention is to achieve the foregoing object with a variety of machine applied adhesives including but not limited to UV cured, hot melt, or water based, that are formulated for FDA approval for indirect contact with food substances and for adhesion in the wet environs of some beverage can filling lines, and optionally also formulated to be antibacterial and/or optionally to release an aroma when it is peeled with the protective member from the container.

Another related object of the invention is to achieve the foregoing object with adhesive as described above and which is formulated to be pressure sensitive adhesive with either a paper or plastic release backing which enables the application of the protective members to the containers in a secondary or separate operation that is not necessarily in line with the can filling operation, and thus does not necessarily have to operate at container filling speeds.

An alternative or complementary object of the invention is to fabricate the protective members from a formulation that includes an antibacterial concentrate additive, which may be used in lieu of, or addition to antibacterial adhesive as described above.

Another object of the invention is to overcome the deficiencies of the prior art by providing sanitation protection not only of the top of the container when used for beverage consumption, but of an adequate portion of the sidewall where the user lower lip contacts the can in proximity to the aperture thereof when opened.

A further object of the invention is to provide sanitation protection that is usable with any container that is used for a food or beverage, including conventional containers that do not have either a pull tab or peel strip opener, such as old fashioned beer cans or soup cans that require a separate top piercing opener.

An additional object of the invention is to provide sanitation protection that includes sufficient bearing strength to avoid having its efficacy impaired by stacking of a considerable number of containers on top of each other, as commonly occurs when “six packs” are stacked directly on top of other six packs to a considerable height, greatly increasing the weight to be borne by the six pack on the bottom of the stack.

A further related object of the invention is to provide sanitation protection that is usable with any containers that are held together in a six pack or similar configuration by a deformable cluster of interconnected plastic rings placed at the necks of the containers.

Still another object of the invention is to provide an apparatus and method of use that is the essence of simplicity.

A related object of the invention is to employ an apparatus and method to achieve the foregoing objectives in a manner which adds no significant costs to the packaging of the beverage so that health and sanitation concerns are addressed without any significant effect on pricing of the product, or which produces revenue to offset the cost of the invention, pay for it in its entirety, or which spins off sufficient revenue to be a separate, new and profitable business.

A still further object of the invention is to provide the foregoing advantages with a protective member that can generate sounds such as sound effects, jingles, music, spoken words, etc. to the consumer using a miniaturized speaker, caseless flexible, flat batteries and a chip processor, to be located in the crevice of the beverage can.

One more object of the invention is to provide the foregoing advantages with a protective member that has been rendered truly biodegradable, even in the absence of light or air, using an additive having a swelling agent, that when combined with heat and moisture, expands the protective member's molecular structure, creating space within that structure, and then utilizing bio-active compounds to attract a colony of microorganisms that metabolize and neutralize the member into an inert humus-like form that is harmless to the environment.

A final object of the invention is to employ the foregoing biodegradation additive as a tracer to establish that protective members lacking this tracer are, in fact, counterfeits.

Other objects and advantages will be apparent to those skilled in the art upon reference to the following descriptions and the accompanying drawings.

In accordance with a primary aspect of the invention, there is provided a new business method that employs an indicia bearing protective member for use in combination with a sanitized food or beverage container, which member, in the case of beverage containers, preferably comprises primarily a substantially hourglass shaped piece of thin material or film of suitable dimension which is adhered to the mouth contact area of beverage containers. Alternatively, a substantially circular member may be used, in which event the member is applied within the rim of the top of the container, especially if the container is a soup can or the like. When the substantially circular member is used, it may be applied to a can end, which can end is subsequently applied to the can with the protective member already attached. This approach makes the present invention applicable to the packaging procedure of one or more special beverage manufacturing entities.

When the hourglass shape is used, it has been found to permit adherence to the top and convex side of a container without deformation of the protective member's material, without the application of heat, and without wrinkling. This is important to avoid air pockets or bubbles, which could become sites for bacterial contamination.

The preferred embodiment of the material is a completely biodegradable blown plastic film primarily comprised of a specific blend consisting of a base of medium density polyethylene mixed with a fifteen to twenty-five percent (15%-25%) addition of linear, low density polyethylene. This specific combination gives the member the required stiffness for it to be dispensed in either of the alternate application methods. These are (a) a cut and stack application wherein adhesive is applied by the application machine, and (b) a pressure sensitive roll, wherein adhesive is separately pre-applied when the pressure sensitive roll is made.

In any event, when the application is the cut and stack method, the member's physical characteristics facilitate it being dispensed from a high-speed label basket (in which thousands of the contact area protective members are tightly stacked). The member's physical characteristics also facilitate it being dispensed from a pressure sensitive roll. The formulation of the member is such that regardless of application method it also retains enough softness and suppleness to precisely conform under the application pressure, in a skin tight manner, to the contours of a food or beverage can top.

The protective member is preferably transparent and manufactured in a unique shape that allows it to be folded over the rim of the beverage can, creating the protection for the lower lip area, without any wrinkling of the material under the application pressure, and without the application of heat. The protective member is formulated to withstand a variety of environmental extremes, i.e., heat, cold, wet, and dry. The protective member may optionally be formulated using an antibacterial additive. An example of such an additive is Polybatch™ Abact antibacterial concentrates available from A. Schulman of Akron, Ohio.

To make the above formulation truly biodegradable independently of the presence of light, air or antibacterial additives, it is also blended before extrusion with about one percent (1%) of a purchased biodegradation additive called ECM MasterBatch Pellets™ that includes several proprietary bioactive compounds. According to the ECM literature and web site, the biodegradation begins with a proprietary swelling agent, that when combined with heat and moisture, expands the plastic's molecular structure. After the swelling agent creates space within the plastic's molecular structure, the bioactive compounds attract a colony of microorganisms that metabolize and neutralize the plastic into an inert humus-like form that is harmless to the environment. Further, the biodegradation additive, being only one percent (1%) of the formulation, is used as a tracer to establish that protective members lacking this tracer are, in fact, counterfeits.

In addition to the preferred embodiment of the formulation, i.e., a base of medium density polyethylene mixed with a fifteen to twenty-five percent (15%-25%) addition of linear, low-density polyethylene, the material is preferably treated in a specific manner. First, only when used in the cut and stack method of application, the material receives an anti-static chemical treatment such that each one of the protective members will slide easily from the adjoining member and not cling to it under high speed dispensing. Second, for both methods of application, the material undergoes a chemical treatment to insure that the adhesive that is added later will bond to the plastic and not to the metal of the can top. This is for the purpose of having a completely clean removal of the protective member and its adhesive without any adhesive residue left on the can itself. Next, since the protective members will usually have indicia applied to them, and this is normally applied by printing, the film of the protective member must be treated to accept and retain printing ink. This treatment is normally an electronic process referred as corona discharge.

The member further includes a protective member tab, which may be of variable length so that it will be easy for the consumer to grasp and which, when the container is a beverage container, is preferably disposed at the lowest point of the member on the sidewall portion of the mouth contact area on the beverage container when the member is hourglass shaped. If the round shape is employed, the tab is at any point around the rim of the container. In either case, there is no adhesive applied to the protective member tab to make it easy for the consumer to grasp. Also included is a re-adherence capability to permit reattachment of the member to the beverage container to accommodate reuse of the member in the event that the entire contents of the container are not all consumed at one time. The indicia will be marketed and sold to third parties that may be unrelated to either the supplier of the invention or the food or beverage company.

In accordance with a further aspect of the present invention, there is disclosed a method for selling third party paid indicia, and placement of same on a member used in the protection scheme of the invention. Also included is sanitizing by any convenient method a portion of a container. This is preferably done with high temperature air, such as can be achieved using Sonic Air Knife Drying Systems™. When the container is a beverage container, this portion is referred to herein as the mouth contact area, including most specifically the top and often also the adjoining sidewall thereof. When the container is one such as a soup can, this portion is the top, especially where the blade of a can opener penetrates. Thereafter the protective member preferably fabricated from the above-described material is adhered to the container. It is this protective member that provides the site for the indicia.

The material in question includes container adherence characteristics, which is preferably the result of a completely biodegradable adhesive. The adhesive will preferably be of transparent antibacterial character that is formulated to remain tacky after the protective member is partially or completely removed so it can be used to reseal the can, or stuck to the side of the can for simple and safe disposal. The adhesive is further formulated for FDA approval for indirect contact with food substances and for adhesion in the wet environs of some beverage can filling lines.

The adhesive is optionally also formulated to release an aroma when it is peeled with the protective member from the container. This feature has been designed to enhance the selling power of one or more advertisers. For example, if the advertiser is the bottler of cherry soda on whose beverage containers the protective member is applied, the aroma could be that of cherries. But if the advertiser were a third party such as a pizza company, the aroma released from the protective member on a beverage can could be that of a freshly baked pizza.

In summary the performance characteristics sought from the adhesive are that it have FDA approval 105 for indirect contact with food substances, leave no residue on the can or other container, be odorless, colorless, and tasteless, remain tacky after peeling, that it be suitable for peel and stick on the side of the can or other container, that it have an appropriate viscosity for high speed application by a gravure etched applicator using minimum application weights, that it stands up to hot, cold, wet and dry environments, that it is effective even in the face of possible aluminum rolling oil residue, that it be antibacterial, biodegradable, and that it have a fragrance releasing capability.

The method further contemplates the packaging, distribution, storage, sale, consumer transportation and opening of the container in a manner designed to avoid compromising the protections afforded by the protective member such that the consumer can be assured that the sanitation benefits are in no way degraded between the time that the sanitation is achieved and the removal of the member.

In accordance with a further aspect of the invention, the indicia may be in the nature of “under the cap” type of promotions. This is uniquely achieved by printing on the underside of the protective member, which may be substantially transparent to reveal the printing, or is preferably opaque so that the protective member must be removed to reveal what is there. The latter approach is particularly well suited for games and promotions, in the manner of a scratch off lottery ticket. It is expected that the protective members can be collected and redeemed for merchandise, premiums, discounts, or prizes. The protective members thus are turned into a truly interactive marketing tool, not just an indicia “billboard.” Indeed, this concept actually is the genesis of a completely new business method—a revolutionary new way of doing business for the canned food and beverage can industry that generates a previously unknown revenue stream and thus benefits all who come in contact with it. It benefits the consumer in several ways, it benefits the food or beverage company in several ways, it benefits the advertiser or promoter, it benefits the manufacturer of the protective members, and finally it benefits the creator of the concept.

A better understanding of the invention may be achieved by reference to the drawings in which:

### BRIEF DESCRIPTION OF DRAWINGS

FIG. 1 is a perspective view of the inventive member shown in combination with a container prior to use thereof and indicating the site of the indicia.

FIG. 2 shows one embodiment of the member of FIG. 1 prior to its application to the container and showing the site of the indicia.

FIG. 3 shows the member and container of FIG. 1 after the container has been opened and the protective member drawn back, such as for consumption of a beverage, if the container is a beverage container.

FIG. 4 is a top plan view of the preferred embodiment of the protective member prior to application to the container and showing its unique and highly significant hourglass shape when used on a beverage container.

FIG. 5 is a top plan view of the alternative embodiment of the protective member prior to application to food or beverage container and showing its round container top conforming shape, such as would be used with a soup can.

### DETAILED DESCRIPTION OF PREFERRED EMBODIMENTS

As required, detailed embodiments of the present invention are disclosed herein; however, it is to be understood that the disclosed embodiments are merely exemplary of the invention that may be embodied in various forms. Therefore, specific structural and functional details disclosed herein are not to be interpreted as limiting, but merely as a basis for the claims and as a representative basis for teaching one skilled in the art to variously employ the present invention in virtually any appropriate detailed structure and associated method.

References now made to the drawings that illustrate the method enabling apparatus, and wherein like characteristics and features of the present invention shown in the various figures are designated by the same reference numerals.

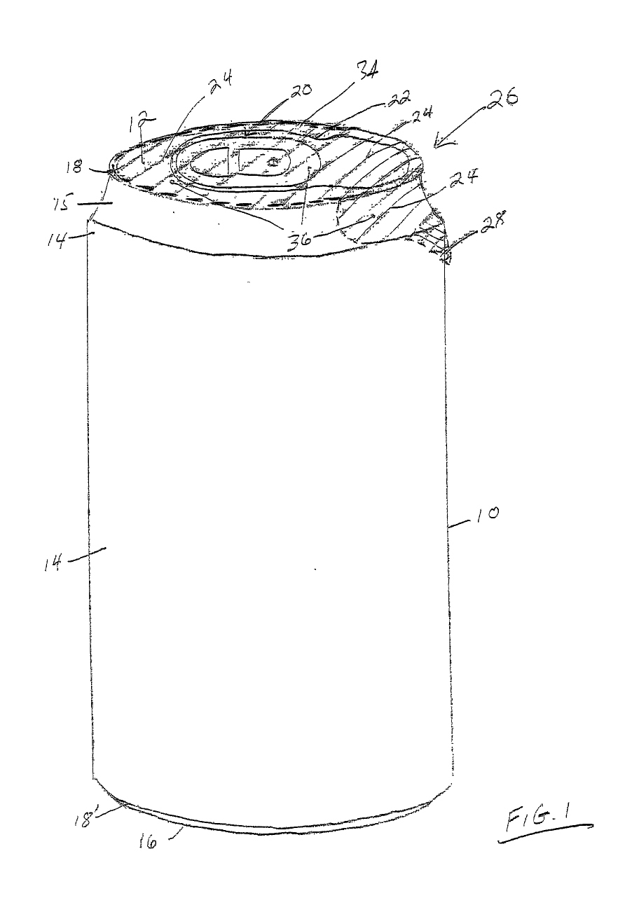

Referring to FIGS. 1-5 a food or beverage container 10 comprising a top 12, a sidewall 14, neck 15 and a bottom 16 is seen. The sidewall 14, neck 15, and bottom 16 are sometimes of one-piece aluminum that is deeply drawn, but almost invariably the top 12 and sidewall 14 are crimped at circumferential rim 18. Some containers include a separate bottom 16 and sidewall 14 joined together at a circumferential rim 18′. Also shown in an eccentric position of the top 12 is a pull tab opener 20 which alternatively may be of pull strip opener or other opening means (not shown). Adjoining the same is the sealed aperture 22.

In combination therewith is the inventive protective member 24 shown in adherence to beverage container 10 and overlapping the sealed aperture 22 as well as sidewall 14 in the mouth contact area 26 of the beverage container 10. Also seen is protective member tab 28 disposed at the lowest point of the sidewall 14 of container 10. It will be seen that protective member tab 28 is at least partially erect from the sidewall 14 of beverage container 10 to make it easy for the user to grasp the same and strip back the protective member 24. Also shown is the site of indicia, which is preferably replaceable, paid, third party indicia 36.

The preferred embodiment of the biodegradable material from which protective member 24 is made is a blown plastic film comprised primarily of a base of medium density polyethylene mixed with a fifteen to twenty-five percent (15%-25%) addition of linear, low density polyethylene. This specific combination gives the member the required stiffness for it to be dispensed in either of the alternate application methods. These are (a) a cut and stack application wherein adhesive is applied by the application machine, and (b) a pressure sensitive roll, wherein adhesive is pre-applied when the pressure sensitive roll is made.

In any event, when the application is the cut and stack method, the member's physical characteristics facilitate it being dispensed from a high-speed label basket (in which thousands of the contact area protective members are tightly stacked). The member's physical characteristics also facilitate it being dispensed from a pressure sensitive roll. The formulation of the member is such that it also retains enough softness and suppleness to precisely conform under the application pressure, in a skintight manner, to the contours of a food or beverage can. The protective member is preferably transparent and manufactured in a unique hourglass shape that allows it to be folded over the rim of the beverage can, creating the protection for the lower lip area, without any wrinkling of the material under the application pressure and without resorting to the application of heat.

To make the above formulation truly biodegradable independently of the presence of light or air, it is also blended before extrusion with about one percent (1%) of a purchased additive called ECM MasterBatch Pellets™ that includes several proprietary bioactive compounds. According to the ECM literature and web site, the biodegradation begins with a proprietary swelling agent, that when combined with heat and moisture, expands the plastic's molecular structure. After the swelling agent creates space within the plastic's molecular structure, the bioactive compounds attract a colony of microorganisms that metabolize and neutralize the plastic into an inert humus-like form that is harmless to the environment. The protective member may optionally be formulated using an antibacterial additive. An example of such an additive is Polybatch™ Abact antibacterial concentrates available from A. Schulman of Akron, Ohio.

In addition to the preferred embodiment of the formulation, the material is preferably treated in a specific manner. First, only when used in the cut and stack method of application, the material receives an anti-static chemical treatment such that each one of the protective members will slide easily from the adjoining member and not cling to it under high speed dispensing. Second, for both methods of application, the material undergoes a chemical treatment to insure that the adhesive that is added later will bond to the plastic and not to the metal of the can top. This is for the purpose of having a completely clean removal of the protective member and its adhesive without any adhesive residue left on the can itself. Next, since the protective members will usually have indicia applied to them, and this is normally applied by printing, the film of the protective member must be treated to accept and retain printing ink. This treatment is normally an electronic process referred as corona discharge.

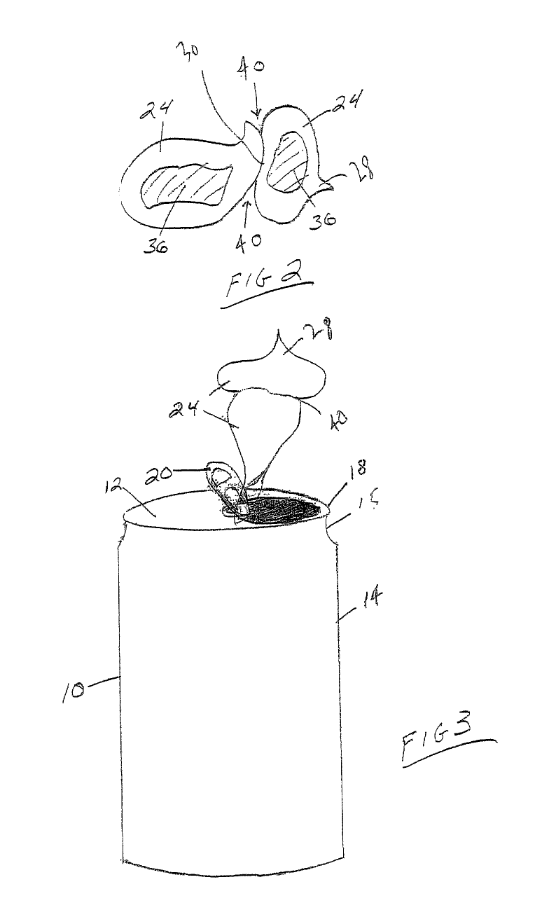

Turning to FIG. 2, there is disclosed the reason that the hourglass shape is so important to the protective member 24. FIG. 2 shows how the hourglass shape fits around the complex shape of the junction of a planar surface, the top 12, and a convex surface, the sidewall 14 and neck 15, at a raised rim 18, and still not wrinkle. It illustrates in this perspective view its convex shape accommodating characteristic 30. It is understood and recognized that although the protective member 24 is a substantially planar material, adherence to the top 12, rim 18, sidewall 14 and neck 15 of container 10 (as seen in FIG. 1) is achieved without wrinkling because of the hourglass shape. Replaceable, paid, third party indicia 36 can also be seen.

Noted in the objects of the invention is the notion of fabricating the protective member 24 from a print receptive substance so that the member may be imprinted with indicia 36. Among the benefits are messages, which may tout the advantages and safety of the invention, which may be numbered for promotions or premiums, and/or as an indicia medium. The latter is contemplated to produce a revenue stream from third parties such that such third parties at least in part pay the costs of the invention, or more beneficially, a new business yielding separate profits from such indicia is achieved. The protective member 24 thereby provides a site for replaceable third party paid indicia 36 in combination with an apparatus and method whereby food and beverage containers may be sanitized and protected from contamination after sanitization by employing a consumer removed, flexible, protective member. Sanitizing is preferably done with high temperature air, which is conventional and is such as can be achieved using Sonic Air Knife Drying Systems™ (not shown).

In FIG. 3, it will be seen that protective member 24 has been stripped upward and backward in proximity to the erect handle of pull tab opener 20. The pull tab opener 20 results in the covering to aperture 22 being depressed within container 10 leaving the opening from which the beverage may be consumed.

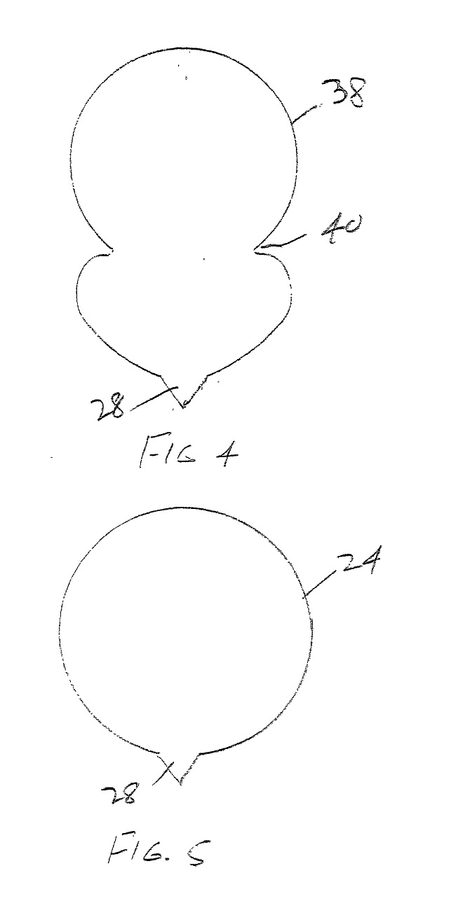

FIG. 4 shows the substantially hourglass shape 38 in which the waist 40 is the key to the ability to have a substantially planar surface conform without wrinkling to the intersection of planar and convex surfaces along sidewall 14, neck 15 and raised rim 18.

Turning to FIG. 5, the alternative embodiment of the protective member is seen with a substantially circular shape and having a tab at any point along its periphery, such as used with soup cans and other food containers and possibly also beverage containers.

The invention further includes an alternative embodiment having a protective member that can that can generate sounds such as sound effects, jingles, music, spoken words, etc. to the consumer using a miniaturized speaker, caseless flexible, flat batteries and a chip processor, to be located in the crevice of the beverage can 34. See FIG. 1. The key aspect of this alternative embodiment is the availability of patented paperlike batteries such as being marketed by Power Paper, Ltd. of Israel in partnership with International Paper in this country. The cell structure may include a paper substrate, a printed layer that forms a cathode, a printed layer of electrolyte, and a printed layer that forms an anode, with conductors connected to the cathode and anode layers to power the chip processor, which in turn is connected to the miniaturized speaker.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as the fall within the breadth and scope of claims appended hereto.

What is claimed is:

1. A business method relating to food and beverage containers comprising:
conveying the right to attach indicia to protective members to be adhered to the containers;
manufacturing the protective members;
applying indicia to the protective members; and
adhering the protective members to the containers.

2. The method of claim 1 in which conveying the right to attach indicia to protective members to be adhered to food and beverage containers is achieved by selling the right to third parties who are neither the container filler nor the protective member manufacturer.

3. The method of claim 1 in which manufacturing the protective members further comprises making them in an hourglass configuration to facilitate adherence to a top and convex side of a container without deformation of the protective member's material, without heat shrink application, and without wrinkling.

4. The method of claim 1 in which manufacturing the protective members further comprises making them primarily from a base of medium density polyethylene mixed with a fifteen to twenty-five percent (15%-25%) addition of linear, low density polyethylene.

5. The method of claim 4 which further comprises formulating the protective members such that they have the physical characteristics to accommodate both the cut and stack, and pressure sensitive methods of application, and also retain enough softness and suppleness to precisely conform under application pressure, in a skin tight manner, to the contours of the containers.

6. The method of claim 4 in which manufacturing the protective members further comprises making them biodegradable regardless of the presence of light and air using a biodegradation additive combined with the polyethylene blend.

7. The method of claim 6 in which the protective member is tested for the presence of the biodegradation additive acting as a tracer to establish that a protective member lacking this tracer is counterfeit.

8. The method of claim 4 in which manufacturing the protective members further comprises making them antibacterial by formulating them using an additive that includes antibacterial concentrates.

9. The method of claim 1 in which manufacturing the protective members further comprises adding a miniature speaker, chip processor and a caseless battery so the protective members can generate sounds to consumers.

10. The method of claim 1 which further comprises sanitizing at least a portion of the containers.

11. The method of claim 1 in which the indicia is at least one of advertising, promotions, games of chance, premiums, collectibles, redeemables, merchandise acquisition means, discounts, prizes, public service announcements, instructional information, and warnings.

12. The method of claim 1 wherein protective members are adhered to containers using adhesive.

13. The method of claim 12 wherein the adhesive is antibacterial.

14. The method of claim 12 wherein the adhesive is formulated to remain tacky after the protective member is at least partially removed from the container to facilitate reattachment of the protective member to a mouth contact area of the container when its contents are not fully consumed, thereby affording continuing protection for later consumption of remaining contents.

15. The method of claim 12 in which the adhesive is transparent.

16. The method of claim 12 in which the adhesive is formulated to release an aroma when the protective member is stripped away from the container.

17. The method of claim 1 which further comprises using the protective member as an isolating layer and attaching to it additional indicia lacking any special preparation for proximity to food and beverages.

18. The method of claim 1 wherein indicia is applied to protective members by printing.

19. The method of claim 18 which further comprises treatment of the protective members to accept and retain printing ink using a corona discharge.

20. The method of claim 15 wherein the indicia is only visible from an underside of the protective members through the transparent adhesive by reverse printing the indicia on transparent protective members, and then printing over the reverse printed indicia with an opaque layer.

21. The method of claim 20 where the underside visibility of the indicia and opaque layer facilitates using the method for such things as games of chance, premiums, collectibles, redeemables, merchandise acquisition means, discounts, and prizes without a consumer knowing in advance of protective member removal which of a plurality of chances the consumer has obtained.

22. The method of claim 1 which further comprises imposing an anti-static chemical treatment on the protective member such that each one of the protective members will slide easily from the adjoining member and not cling to it under high speed dispensing.

23. The method of claim 1 which further comprises imposing chemical treatment on the protective member such that adhesive will bond more strongly to the member and less strongly to metal of the container.
